(19) United States
(12) Patent Application Publication
(10) Pub. No.: US 2026/0141846 A1
(43) Pub. Date: May 21, 2026

(54) LED DISPLAY DRIVING CIRCUIT AND LED DISPLAY DEVICE INCLUDING THE SAME

(71) Applicant: LX Semicon Co., Ltd., Daejeon (KR)

(72) Inventors: Ji Hwan KIM, Daejeon (KR); Yoon Soo SHIN, Daejeon (KR); Jang Su KIM, Daejeon (KR); Sang Suk KIM, Daejeon (KR); Sang Woo LEE, Daejeon (KR); Jin Ho CHOI, Daejeon (KR)

(73) Assignee: LX Semicon Co., Ltd., Daejeon (KR)

(21) Appl. No.: 19/394,654

(22) Filed: Nov. 19, 2025

(30) Foreign Application Priority Data
Nov. 20, 2024 (KR) 10-2024-0166584
Apr. 30, 2025 (KR) 10-2025-0056950

(51) Int. Cl. G09G 3/32

(52) U.S. Cl. CPC G09G 3/32; G09G 2310/08; G09G 2320/0233; G09G 2320/0257; G09G 2330/12

(57) ABSTRACT

A light-emitting diode (LED) display driving circuit includes a channel driving circuit configured to supply a channel current to each of a plurality of channel lines to which a plurality of LEDs are connected according to a pulse width modulation (PWM) control signal, a scan driving circuit including a plurality of scan switches configured to selectively drive each scan line to cause the plurality of LEDs to emit light, and a plurality of precharge switches which are turned on when the scan switches are turned off and supply a precharge voltage to the scan lines, a short-circuit detection unit configured to detect whether the plurality of LEDs are short-circuited and a short-circuit degree, a data controller which, when a short-circuited LED is detected, turns off a precharge switch of a target scan line, to which the short-circuited LED is connected, when the scan switch of the target scan line is turned off, and maintains the target scan line in a floating state, and a luminance compensation unit configured to compensate luminance of normal LEDs connected to the target channel line to which the short-circuited LED is connected according to a short-circuit degree of the short-circuited LED during driving of the scan lines excluding the target scan line.

### CROSS-REFERENCE TO RELATED APPLICATIONS

This application claims the benefit of the Korean Patent Applications No. 10-2024-0166584 filed on Nov. 20, 2024 and No. 10-2025-0056950 filed on Apr. 30, 2025, which are hereby incorporated by reference as if fully set forth herein.

### BACKGROUND

### Field of the Invention

The present disclosure relates to a display device, and more specifically, to a light-emitting diode (LED) display.

### Discussion of the Related Art

With the advancement of informatization, various display devices capable of visualizing information are being developed. Display devices that have been developed or are being developed include liquid crystal display (LCD) devices, organic light-emitting diode (OLED) display devices, and plasma display panel (PDP) display devices. These display devices are advancing to appropriately display high-resolution images.

However, the above-described display devices have the advantage of high resolution but have the disadvantage of being difficult to scale up. For example, large OLED display devices developed to date have sizes ranging from 80 inches (approximately 2 m) to 100 inches (approximately 2.5 m) and are unsuitable for manufacturing large display devices with a width exceeding 10 m.

As a way to solve such a problem of enlargement, interest in light-emitting diode (LED) display devices has been increasing recently. In LED display device technologies, the required number of modularized LED pixels may be disposed to constitute one large panel. Alternatively, in LED display device technologies, the required number of unit panels including a plurality of LED pixels may be disposed to form one large panel structure. In this way, in LED display device technologies, a large display device may be easily implemented by increasing the number of LED pixels as needed and arranging the increased number of LED pixels.

LED display devices have the advantage of not only increasing a size but also diversifying panel sizes. LED display device technologies allow horizontal and vertical sizes to be adjusted in various ways according to the appropriate arrangement of LED pixels.

In LED display devices described above, when an LED of a specific pixel is short-circuited, there is a problem that the luminance of all normal LEDs connected to the same channel line as the short-circuited LED may become brighter (bright line) or darker (dim line) due to the short-circuited LED, resulting in image quality degradation.

To solve this problem, a way to detect and repair short-circuited LEDs or replace the short-circuited LEDs with normal LEDs may be considered, but there is a problem that repairing or replacing short-circuited LEDs is costly and time-consuming.

### SUMMARY

The present disclosure is directed to providing a light-emitting diode (LED) display driving circuit capable of detecting not only a fully short-circuited LED but also a partially short-circuited LED, and an LED display device including the same.

The present disclosure is also directed to providing an LED display driving circuit capable of reducing line defects caused by a short-circuited LED, and an LED display device including the same.

The present disclosure is also directed to providing an LED display driving circuit capable of compensating for the luminance of a normal LED connected to the same channel line as a short-circuited LED according to a short-circuit degree of the short-circuited LED, and an LED display device including the same.

According to an aspect of the present disclosure, there is provided an LED display driving circuit including a channel driving circuit configured to supply a channel current to each of a plurality of channel lines to which a plurality of LEDs are connected according to a pulse width modulation (PWM) control signal, a scan driving circuit including a plurality of scan switches configured to selectively drive each scan line to cause the plurality of LEDs to emit light, and a plurality of precharge switches which are turned on when the scan switches are turned off and supply a precharge voltage to the scan lines, a short-circuit detection unit configured to detect whether the plurality of LEDs are short-circuited and a short-circuit degree, a data controller which, when a short-circuited LED is detected, turns off a precharge switch of a target scan line, to which the short-circuited LED is connected, when the scan switch of the target scan line is turned off, and maintains the target scan line in a floating state, and a luminance compensation unit configured to compensate luminance of normal LEDs connected to the target channel line to which the short-circuited LED is connected according to a short-circuit degree of the short-circuited LED during driving of the scan lines excluding the target scan line.

According to another aspect of the present disclosure, there is provided an LED display device including a display panel including a plurality of LEDs, and an LED display driving circuit configured to supply a channel current to the plurality of LEDs to cause the plurality of LEDs to emit light, wherein the LED display driving circuit includes a channel driving circuit configured to supply the channel current through each channel line according to a PWM control signal, a scan driving circuit including a plurality of scan switches configured to selectively drive each scan line to cause the plurality of LEDs to emit light, and a plurality of precharge switches which are turned on when the scan switches are turned off and supply a precharge voltage to the scan lines, a short-circuit detection unit configured to detect whether the plurality of LEDs are short-circuited and a short-circuit degree, a data controller which, when a short-circuited LED is detected, turns off a precharge switch of a target scan line, to which the short-circuited LED is connected, when the scan switch of the target scan line is turned off, and maintains the target scan line in a floating state, and a luminance compensation unit configured to compensate luminance of normal LEDs connected to the target channel line to which the short-circuited LED is connected according to a short-circuit degree of the short-circuited LED during driving of the scan lines excluding the target scan line.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a diagram illustrating a configuration of a light-emitting diode (LED) display device according to one embodiment of the present disclosure;

FIG. 2 is a schematic diagram illustrating a configuration of an LED display driving circuit according to one embodiment of the present disclosure;

FIG. 3 is a diagram showing a waveform of a scan signal in the LED display device according to one embodiment of the present disclosure;

FIG. 4 is a timing diagram showing operation timings of some components of a normal LED display device shown in FIG. 3;

FIGS. 5A and 5B are drawings illustrating a line defect phenomenon caused by a short-circuited LED;

FIG. 6A is a diagram illustrating a phenomenon (bright line) in which all LEDs connected to a first channel line become brighter when a level of a precharge voltage is higher than that of a first channel voltage of a first channel line to which a short-circuited LED is connected;

FIG. 6B is a diagram illustrating a phenomenon (dim line) in which all LEDs connected to the first channel line becomes darker when a level of a precharge voltage is lower than that of the first channel voltage of the first channel line to which the short-circuited LED is connected;

FIG. 7 is a timing diagram showing operation timings of some components of an LED display device including a short-circuited LED;

FIG. 8 is a schematic block diagram illustrating a configuration of a short-circuit detection unit according to one embodiment of the present disclosure;

FIG. 9 is a diagram illustrating an example in which a short-circuit degree is detected, and a luminance compensation amount is determined based on the short-circuit degree according to one embodiment of the present disclosure;

FIG. 10 is a schematic block diagram illustrating a configuration of a luminance compensation unit according to one embodiment of the present disclosure;

FIG. 11 is a schematic block diagram illustrating a configuration of a luminance compensation amount generation unit according to one embodiment of the present disclosure;

FIG. 12 is a diagram illustrating an example of a short-circuit emulation circuit according to one embodiment of the present disclosure;

FIG. 13 is a schematic block diagram illustrating a configuration of an error detection unit according to one embodiment of the present disclosure;

FIG. 14 is a diagram showing a waveform of a counter enable signal and a luminance compensation amount according to a short-circuit degree;

FIG. 15 is a flowchart illustrating a method of a luminance compensation amount generation unit generating a luminance compensation amount according to each short-circuit degree according to one embodiment of the present disclosure; and

FIGS. 16A and 16B are drawings showing a dot defect phenomenon (dot dim) in which only a short-circuited LED does not emit light.

### DETAILED DESCRIPTION OF THE DISCLOSURE

Advantages and features of the present disclosure, and implementation methods thereof will be clarified through following exemplary embodiments described with reference to the accompanying drawings. The present disclosure can, however, be embodied in different forms and should not be construed as limited to the exemplary embodiments set forth herein. Rather, these exemplary embodiments are provided so that this disclosure will be thorough and complete, and will fully convey the scope of the present disclosure to those skilled in the art. Further, the present disclosure is only defined by scopes of claims.

Throughout the present disclosure, identical reference numerals refer to substantially identical elements. In the following description, when the detailed description of the relevant known function or configuration is determined to unnecessarily obscure the important point of the present disclosure, the detailed description will be omitted. In addition, the names of the elements used in the description below are examples and can differ from the names of the actual product corresponding to the elements.

In a case where ‘comprise,’ ‘have,’ and ‘include’ described in the present disclosure are used, another part can be added. The terms of a singular form can include plural forms unless referred to the contrary.

In construing an element, the element is construed as including an error range although there is no explicit description.

It will be understood that, although the terms “first”, “second”, etc. can be used herein to describe various elements, these elements should not be limited by these terms. These terms are only used to distinguish one element from another. Accordingly, a first element mentioned hereinafter could be termed a second element without departing from the scope of the present disclosure.

The term “at least one” should be understood as including any and all combinations of one or more of the associated listed items. For example, the meaning of “at least one of a first item, a second item, and a third item” denotes each of the first item, the second item, and the third item as well as the combination of all items proposed from two or more of the first item, the second item, and the third item.

Features of various exemplary embodiments of the present disclosure can be partially or overall coupled to or combined with each other and can be variously inter-operated or combined with each other and driven technically as those skilled in the art can sufficiently understand. The exemplary embodiments of the present disclosure can be carried out independently from each other, or can be carried out together in co-dependent relationship.

Hereinafter, exemplary embodiments of the present disclosure will be described in detail with reference to the accompanying drawings.

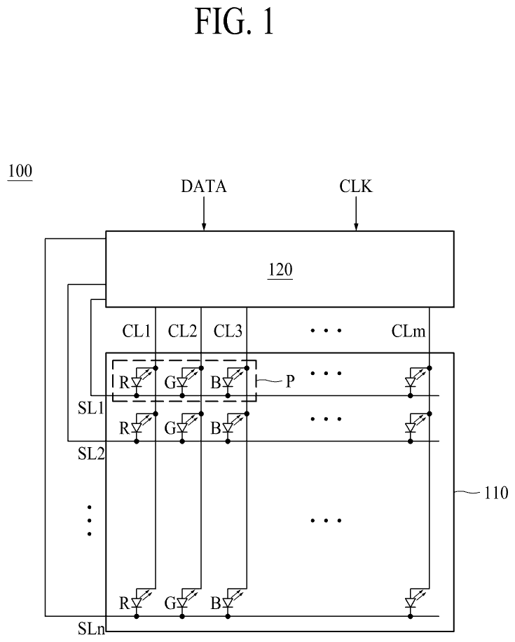

FIG. 1 is a diagram illustrating a configuration of a light-emitting diode (LED) display device according to one embodiment of the present disclosure.

As shown in FIG. 1, an LED display device 100 according to one embodiment of the present disclosure includes a display panel 110 and an LED display driving circuit 120.

The display panel 110 includes a plurality of pixels P. The plurality of pixels P may be disposed in a matrix form in a first direction (for example, a horizontal direction in FIG. 1) and a second direction (for example, a vertical direction in FIG. 1). At least one LED may be disposed in each pixel P, and the luminance of the pixel P may be determined according to the luminance of the LED. That is, the display panel 110 may be an LED display panel.

Each pixel P may include a plurality of subpixels. As an example, each pixel P may include three subpixels. Each pixel P may include a red subpixel expressing red, a green subpixel expressing green, and a blue subpixel expressing blue. One LED may be disposed in each subpixel.

A plurality of channel lines CL1 to CLm and a plurality of scan lines SL1 to SLn are disposed in the display panel 110. Each subpixel may be disposed in an area in which the channel line intersects the scan line. That is, the LED disposed in each subpixel may be electrically connected to one channel line of the channel lines CL1 to CLm and one scan line of the scan lines SL1 to SLn.

Each of the channel lines CL1 to CLm may connect one side of each of the subpixels in the second direction, and each of the scan lines SL1 to SLn may connect the other side of each of the subpixels in the first direction. For example, anodes of the LEDs disposed in the subpixels may be electrically connected to the channel lines CL1 to CLm, and cathodes of the LEDs may be electrically connected to the scan lines SL1 to SLn. The example shown in FIG. 1 is also referred to as a common cathode structure in that the cathodes of the LEDs are commonly connected, but the present embodiment is not limited to such a structure.

The LED display driving circuit 120 supplies a channel current to a plurality of LEDs included in the display panel 110 to cause the plurality of LEDs to emit light. In one embodiment, the LED may be driven in a pulse width modulation (PWM) manner, and the LED display driving circuit 120 may perform PWM control on each pixel P according to image data DATA received from the outside.

The image data DATA may include a grayscale value for each pixel P, and the LED display driving circuit 120 may receive the image data DATA from the outside according to a clock CLK and may obtain a grayscale value for each pixel P from the image data DATA.

The LED display driving circuit 120 may determine a PWM control time for the LED disposed in each subpixel according to the grayscale value and may perform PWM control on each LED. As described above, when the LED is driven in a PWM manner, the luminance of the LED may be determined according to a ratio of a turn-on time to the PWM control time. Accordingly, the LED display driving circuit 120 may control the luminance of the LED by controlling the turn-on time in the PWM control time.

Specifically, the luminance of the LED disposed in each subpixel may be determined according to an amount of a channel current supplied through the channel lines CL1 to CLm to which the LED is connected. When the LED is turned on by a channel current, a forward voltage may be generated in the LED. When the product of the forward voltage and the channel current is accumulated over the turn-on time in the PWM control time, an amount of driving power supplied to the LED may be obtained, and the luminance of the LED may be determined according to the amount of driving power.

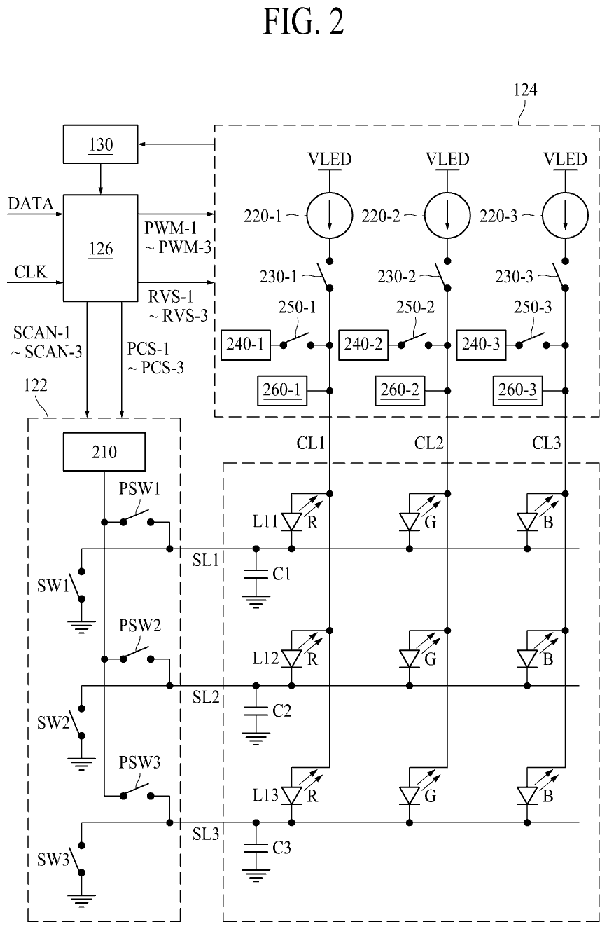

Hereinafter, the LED display driving circuit according to the present disclosure will be described in more detail with reference to FIG. 2.

FIG. 2 is a schematic diagram illustrating a configuration of the LED display driving circuit according to one embodiment of the present disclosure. For convenience of description, in FIG. 2, the display panel 110 is illustrated as including three scan lines SL1 to SL3, three channel lines CL1 to CL3, and nine LEDs.

As shown in FIG. 2, the LED display driving circuit 120 may include a scan driving circuit 122, a channel driving circuit 124, a data controller 126, and a luminance compensation unit 130.

The scan driving circuit 122 is connected to a plurality of scan lines SL1 to SL3 to drive the scan lines SL1 to SL3 according to scan signals SCAN_1 to SCAN_3 supplied from the data controller 126. To this end, as shown in FIG. 2, the scan driving circuit 122 includes a plurality of scan switches SW1 to SW3.

Since the display panel 110 is illustrated in FIG. 2 as including only three scan lines SL1 to SL3, the scan driving circuit 122 is illustrated as including only three scan switches SW1 to SW3. However, when the display panel 110 includes n scan lines SL1 to SLn, the scan driving circuit 122 may include n scan switches SW1 to SWn.

The plurality of scan switches SW1 to SW3 are connected to the scan lines SL1 to SL3. The plurality of scan switches SW1 to SW3 are selectively turned on or off according to the scan signals SCAN_1 to SCAN_3 supplied from the data controller 126. As a corresponding scan switch of the scan switches SW1 to SW3 is turned on according to the supply of the scan signals SCAN_1 to SCAN_3, each of the scan lines SL1 to SL3 may be connected to a low voltage part in the LED display device 100 such as a level of a ground GND.

As the scan switches SW1 to SW3 are selectively turned on or off according to the scan signals SCAN_1 to SCAN_3, the scan line SL1, SL2, or SL3 to which a channel current is supplied among the plurality of scan lines SL1 to SL3 is determined.

In the above-described embodiment, it has been described that the scan switches SW1 to SW3 are formed within the LED display driving circuit 120, but in other embodiments, the scan switches SW1 to SW3 may be formed in the display panel 110 or may be formed on a separate substrate.

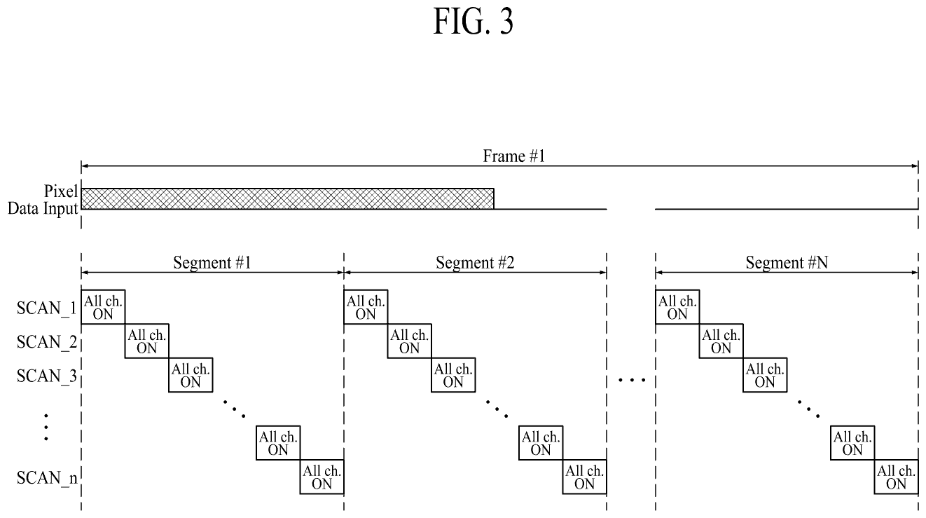

FIG. 3 is a diagram showing a waveform of a scan signal in the LED display device according to one embodiment of the present disclosure.

Referring to FIGS. 1 and 3, one frame includes N segments (N is a natural number), and scan signals SCAN_1 to SCAN_n may be sequentially supplied to the scan switches SW1 to SWn for each segment unit. Here, a frame may be each image that constitutes a video, and one segment may be a unit in which one cycle of a scan operation is performed.

According to the scan signals SCAN_1 to SCAN_n, a first to n^{th} scan lines SL1 to SLn may be sequentially driven. However, according to embodiments, a scan operation may not be sequentially performed from the first scan line SL1 to the n^{th} scan line SLn. For example, the order of a scan operation may be determined in consideration of printed circuit board (PCB) routing.

In one embodiment, when each subpixel is PWM-controlled once in one frame, a grayscale value may be converted directly into a PWM control value, and each subpixel may be controlled according to the PWM control value. On the other hand, when one frame is divided into N segments, a grayscale value may be divided and allocated to the N segments, and a PWM control value may be determined according to a grayscale value allocated to each segment. In this case, each subpixel may be controlled according to the PWM control value converted according to the grayscale value allocated to each segment.

Referring again to FIG. 2, the scan driving circuit 122 according to the present disclosure may further include a precharge voltage supply unit 210 and precharge switches PSW1 to PSW3. Since the display panel 110 is illustrated in FIG. 2 as including only three scan lines SL1 to SL3, the scan driving circuit 122 is illustrated as including only three precharge switches PSW1 to PSW3. However, when the display panel 110 includes n scan lines SL1 to SLn, the scan driving circuit 122 may include n precharge switches PSW1 to PSWn.

In order to prevent the occurrence of a ghost phenomenon in which an LED, which is connected to the scan lines SL1 to SL3 of which a scan operation has ended, emits light, the precharge voltage supply unit 210 supplies a precharge voltage Vprecharge to the scan lines SL1 to SL3 of which the scan operation has ended. Precharge refers to an operation of charging capacitors C1 to C3 connected to the scan lines SL1 to SL3 of which a scan operation has ended, before a scan operation of other scan lines SL3 to SLn is started. Precharge may be performed between a time point at which a scan operation ends and a time point at which a next scan operation starts.

As the precharge voltage supply unit 210 precharges the capacitors C1 to C3, a voltage of the capacitors C1 to C3 may increase. Accordingly, an LED connected to the capacitors C1 to C3 is maintained in a reverse bias state so that no current may flow to the LED. Accordingly, the LED connected to the capacitors C1 to C3 of the scan lines SL1 to SL3 of which the scan operation has ended may not emit light.

In this case, the capacitors C1 to C3 may be parasitic capacitors of LEDs. The capacitors C1 to C3 may be capacitors that form electrostatic capacitance inside the LED display device 100 according to the operation of the LED display driving circuit 120 or the display panel 110. The capacitors C1 to C3 may be virtual capacitors rather than physical capacitors.

The capacitors C1 to C3 form a capacitance between the LED and each of the scan switches SW1 to SW3. Although the display panel 110 is illustrated in FIG. 2 as including three capacitors C1 to C3, when the display panel 110 includes n scan lines SL1 to SLn, the display panel 110 may include n capacitors C1 to Cn.

The precharge switches PSW1 to PSW3 are selectively turned on or off by precharge control signals PCS_1 to PCS_3 generated by the data controller 126, thereby supplying a precharge voltage to each of the scan lines SL1 to SL3. When the precharge switches PSW1 to PSW3 are turned on by the precharge control signals PCS_1 to PCS_3, the scan lines SL1 to SL3 are connected to the precharge voltage supply unit 210, and the capacitors C1 to C3 of the scan lines SL1 to SL3 are charged with a precharge voltage.

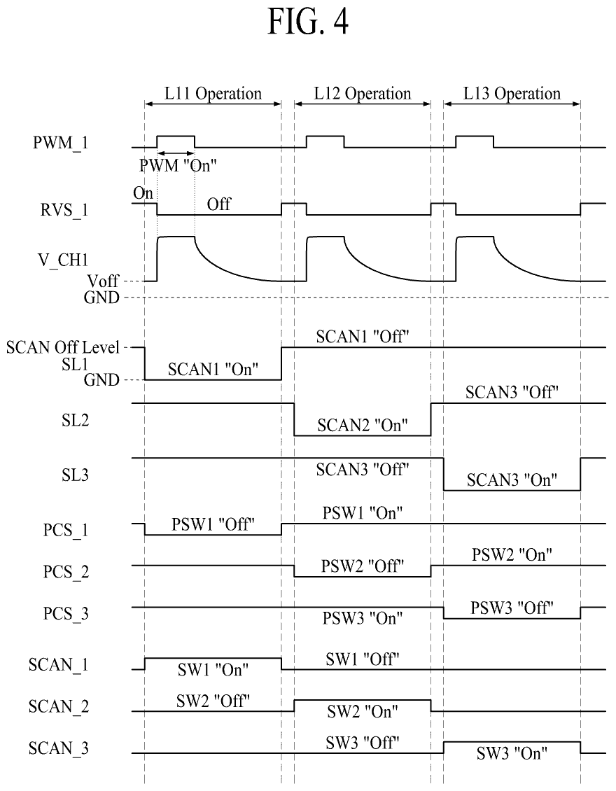

Hereinafter, a scan operation and a precharge operation performed in the first scan line SL1 will be briefly described with reference to FIG. 4.

FIG. 4 is a timing diagram showing an operation timing of each component of the LED display device shown in FIG. 3.

As shown in FIG. 4, a first scan switch SW1 is turned on in response to a first scan signal SCAN_1, and thus the first scan line SL1 is connected to a ground. In this case, a first precharge switch PSW1 is turned off according to a first precharge control signal PCS_1. Accordingly, a voltage of a first capacitor C1 disposed on the first scan line SL1 may decrease from a time point at which the first scan switch SW1 is turned on and may be maintained at a minimum value until a time point at which the first scan switch SW1 is turned off.

Thereafter, the first scan switch SW1 is turned off according to the first scan signal SCAN_1 so that the first scan line SL1 is maintained at a scan-off level, and after a predetermined time has elapsed, a second scan switch SW2 is turned on in response to a second scan signal SCAN_2. In this case, the second scan switch SW2 is turned on after a predetermined time has elapsed from a turn-off time point of the first scan switch SW1 to prevent LEDs connected to the first and second scan lines SL1 and SL2 from simultaneously emitting light due to an overlapping operation of the first scan line SL1 and a second scan line SL2.

Meanwhile, simultaneously when the first scan switch SW1 is turned off, the first precharge switch PSW1 is turned on by the first precharge control signal PCS_1 so that the first capacitor C1 connected to the first scan line SL1 is charged with a precharge voltage. As a charge amount of the first capacitor C1 increases, a voltage of the first capacitor C1 may increase. A voltage of the first capacitor C1 may reach a maximum value before a time point at which the second scan switch SW2 is turned on and may be maintained at the maximum value until the first scan line SL1 is driven again.

That is, the first capacitor C1 may be precharged between a time point at which the first scan switch SW1 is turned off and a time point at which the second scan switch SW2 is turned on. Since the voltage of the first capacitor C1 is maintained at the maximum value as the first capacitor C1 is precharged, LEDs connected to the first capacitor C1 may be maintained in a reverse bias state, and thus a ghost phenomenon may be prevented.

Afterwards, the second scan switch SW2 is turned on according to the second scan signal SCAN_2, and thus the second scan line SL2 is connected to the ground. In this case, a second precharge switch PSW2 is turned off according to a second precharge control signal PCS_2. Accordingly, a voltage of the second capacitor C2 disposed on the second scan line SL2 may decreases from a time point at which the second scan switch SW2 is turned on and may be maintained at a minimum value until a time point at which the second scan switch SW2 is turned off.

Thereafter, the second scan switch SW2 is turned off according to the second scan signal SCAN_2 so that the second scan line SL2 is maintained at a scan-off level, and after a predetermined time has elapsed, a third scan switch SW3 is turned on according to a third scan signal SCAN_3.

Meanwhile, simultaneously when the second scan switch SW2 is turned off, the second precharge switch PSW2 is turned on by the second precharge control signal PCS_2 so that the second capacitor C2 connected to the second scan line SL2 is charged with a precharge voltage. As a charge amount of the second capacitor C2 increases, a voltage of the second capacitor C2 may increase. A voltage of the second capacitor C2 may reach a maximum value before a time point at which the third scan switch SW3 is turned on and may be maintained at the maximum value until the second scan line SL2 is driven again.

That is, the second capacitor C2 may be precharged between a time point at which the second scan switch SW2 is turned off and a time point at which the third scan switch SW3 is turned on, and since the voltage of the second capacitor C2 is maintained at the maximum value as the second capacitor C2 is precharged, LEDs connected to the second capacitor C2 may be maintained in a reverse bias state, and thus a ghost phenomenon may be prevented.

Afterwards, the third scan switch SW3 is turned on according to the third scan signal SCAN_3, and thus the third scan line SL3 is connected to the ground. In this case, a third precharge switch PSW3 is turned off according to a third precharge control signal PCS_3. Accordingly, a voltage of a third capacitor C3 disposed on the third scan line SL3 may decrease from a time point at which the third scan switch SW3 is turned on and may be maintained at a minimum value until the time the third scan switch SW3 is turned off.

Thereafter, the third scan switch SW3 is turned off according to the third scan signal SCAN_3 so that the third scan line SL3 is maintained at a scan-off level, and after a predetermined time has elapsed, a fourth scan switch SW4 is turned on according to a fourth scan signal SCAN_4.

Meanwhile, simultaneously when the third scan switch SW3 is turned off, the third precharge switch PSW3 is turned on by the third precharge control signal PCS_3 so that the third capacitor C3 connected to the third scan line SL3 is charged with a precharge voltage. As a charge amount of the third capacitor C3 increases, a voltage of the third capacitor C3 may increase. A voltage of the third capacitor C3 may reach a maximum value before a time point at which the fourth scan switch SW4 is turned on and may be maintained at the maximum value until the third scan line SL3 is driven again.

That is, the third capacitor C3 may be precharged between a time point at which the third scan switch SW3 is turned off and a time point at which the fourth scan switch SW4 is turned on, and since the voltage of the third capacitor C3 is maintained at the maximum value as the third capacitor C3 is precharged, the LEDs connected to the third capacitor C3 may be maintained at a reverse bias state, and thus a ghost phenomenon may be prevented.

Referring again to FIG. 2, the channel driving circuit 124 is connected to the plurality of channel lines CL1 to CLm and supplies a channel current to subpixels connected to the channel lines CL1 to CLm through the channel lines CL1 to CLm. In this case, the channel driving circuit 124 may control an amount of a channel current supplied to LEDs connected to the channel line CL1 to CLm according to PWM control signals PWM_1 to PWM_m supplied from the data controller 126.

To this end, the channel driving circuit 124 may include channel current sources 220_1 to 220_m and PWM switches 230_1 to 230_m for the channel lines CL1 to CLm.

In FIG. 2, for convenience of description, only three channel lines CL1 to CL3 included in the display panel 110 are illustrated, and thus the channel driving circuit 124 is illustrated as including first to third channel current sources 220_1 to 220_3 and first to third PWM switches 230_1 to 230_3. However, when the display panel 110 includes m channel lines CL1 to CLm, the channel driving circuit 124 may include m channel current sources 220_1 to 220_m and m PWM switches 230_1 to 230_m.

The operations of the first to third channel current sources 220_1 to 220_3 are identical to each other, and the operations of the first to third PWM switches 230_1 to 230_3 are identical to each other. Therefore, hereinafter, only the operations of the first channel current source 220_1 and the first PWM switch 230_1 will be described.

The first channel current source 220_1 may generate a channel current using an LED driving voltage VLED supplied from the outside. The channel current generated by the first channel current source 220_1 may be supplied to LEDs connected to a first channel line CL1 through the first channel line CL1. The first channel current source 220_1 may be connected in series between an LED driving voltage VLED application line and the first PWM switch 230_1.

The first PWM switch 230_1 is selectively turned on or off according to a first PWM control signal PWM_1 received from the data controller 126, thereby adjusting a time for which a channel current is supplied through the first channel line CL1.2 An amount of a channel current supplied through the first channel line CL1 may be determined according to a time for which the first PWM switch 230_1 is turned on. Accordingly, the luminance of LEDs connected to the first channel line CL1 can be determined.

As shown in FIG. 4, the first PWM control signal PWM_1 may include an ON section and an OFF section (corresponding to a section excluding the ON section). The first PWM switch 230_1 is turned on in the ON section of the first PWM control signal PWM_1 to supply a channel current supplied from the first channel current source 220_1 to the first channel line CL1 and is turned off in the OFF section of the first PWM control signal PWM_1 to block a channel current supplied from the first channel current source 220_1 from being supplied to the first channel line CL1.

The first PWM switch 230_1 may be connected in series between an LED and the first channel current source 220_1.

In one embodiment, as shown in FIG. 4, during driving of each of the scan lines SL1 to SL3, when the first PWM control signal PWM_1 is turned on, and a channel current is supplied to the first channel line CL1, a first channel voltage V_CH1 applied to the first channel line CL1 may increase from a level of a reference voltage Voff higher than a level of the ground GND, and when the first PWM control signal PWM_1 is turned off, and the supply of a channel current is stopped, the first channel voltage V_CH1 may decrease again to the level of the reference voltage Voff.

In the present disclosure, the reason why the first channel voltage V_CH1 applied to the first channel line CL1 is maintained at the level of the reference voltage Voff higher than the level of the ground GND during driving of each of the scan lines SL1 to SL3 is to reduce a time taken for the first channel voltage V_CH1 of the first channel line CL1 to increase to a maximum value according to the supply of a channel current.

To this end, as shown in FIG. 2, the channel driving circuit 124 according to the present disclosure may additionally include a first reference voltage generation circuit 240_1 for generating the reference voltage Voff and a first reference voltage application switch 250_1 for selectively applying the reference voltage Voff to the first channel line CL1. In this case, the first reference voltage application switch 250_1 may be selectively turned on or off according to a first reference voltage application signal RVS_1 transmitted from the data controller 126.

In FIG. 2, for convenience of description, only three channel lines CL1 to CL3 included in the display panel 110 are illustrated, and thus the channel driving circuit 124 is illustrated as including first to third reference voltage generation circuits 240_1 to 240_3 and first to third reference voltage application switches 250_1 to 250_3. However, when the display panel 110 includes m channel lines CL1 to CLm, the channel driving circuit 124 may include m reference voltage generation circuits 240_1 to 240_m and m reference voltage application switches 250_1 to 250_m.

The data controller 126 may generate the scan signals SCAN_1 to SCAN_n, the PWM control signals PWM_1 to PWM_m, precharge control signals PCS_1 to PCS_n, and reference voltage application signals RVS_1 to RVS_m. The data controller 126 applies the scan signals SCAN_1 to SCAN_n and the precharge control signals PCS_1 to PCS_n to the scan driving circuit 122 and applies the PWM control signals PWM_1 to PWM_m and the reference voltage application signals RVS_1 to RVS_m to the channel driving circuit 124.

In one embodiment, the data controller 126 may adjust a length of an on-section of each of the PWM control signal PWM_1 to PWM_m according to an internal clock GCLK. The data controller 126 may adjust the length of the on-section of each of the PWM control signals PWM_1 to PWM_m by corresponding one unit of a grayscale value to one cycle of the internal clock GCLK. For example, when a grayscale value is 1, the length of the on-section of each of the PWM control signal PWM_1 to PWM_m may be equal to one cycle of the internal clock GCLK.

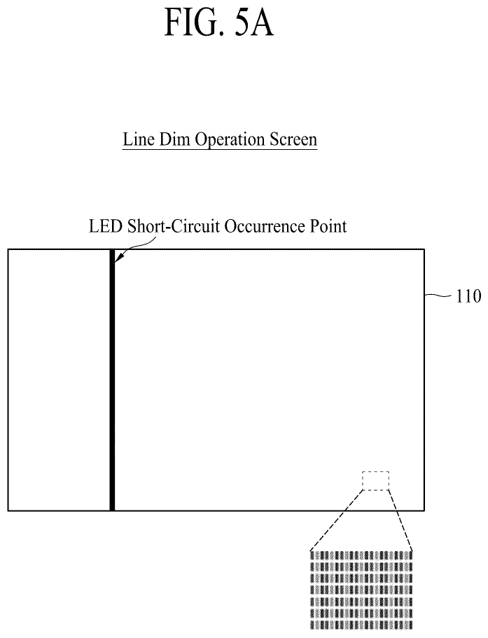

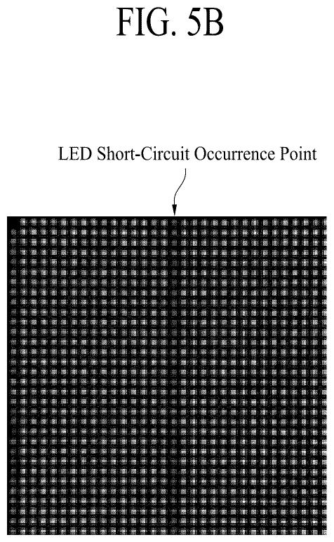

In the LED display device 100 as described above, when any one of the plurality of LEDs included in the display panel 110 is short-circuited, as shown in FIGS. 5A and 5B, a line defect phenomenon may occur in which the luminance of all LEDs connected to a corresponding channel line becomes brighter or darker.

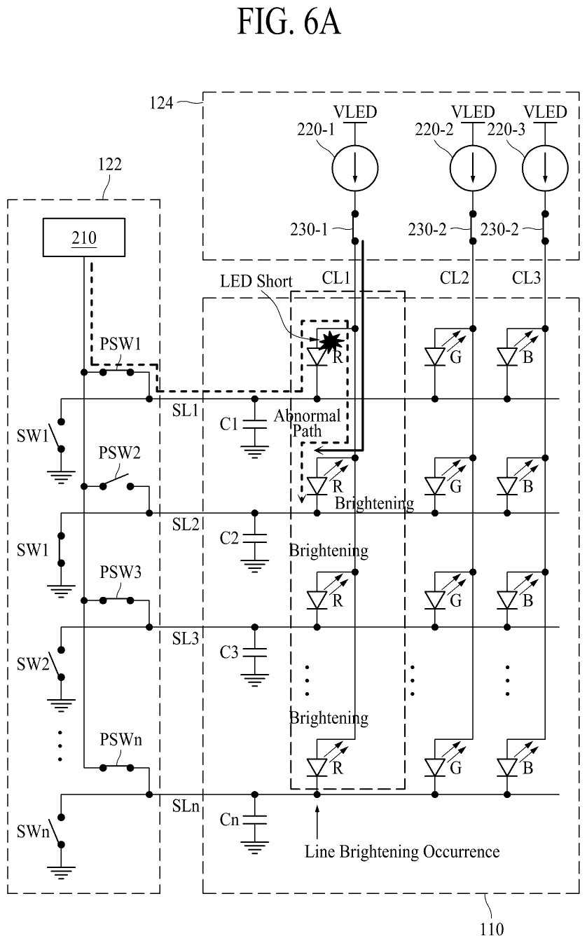

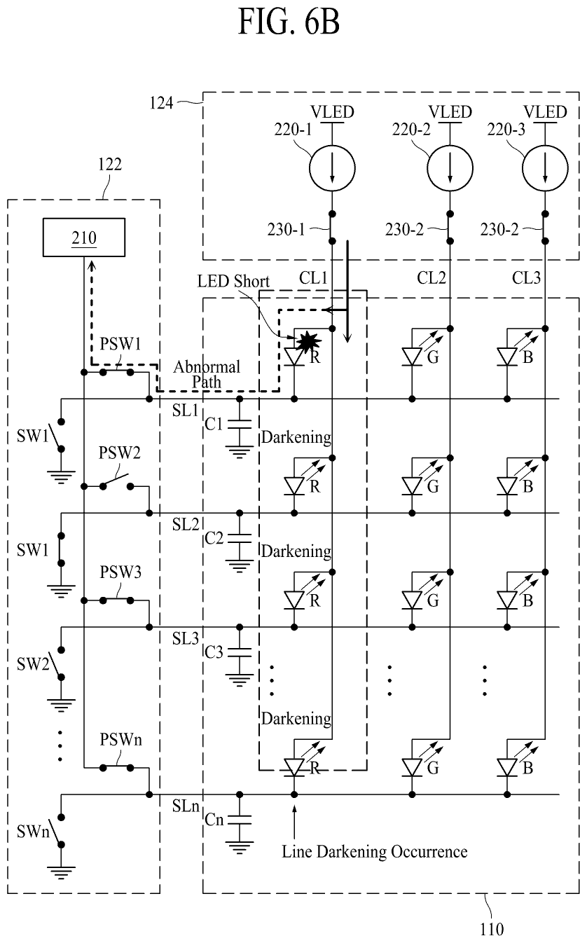

Specifically, as shown in FIG. 6A, when a first LED L11 connected to the first channel line CL1 and the first scan line SL1 is short-circuited, and a level of a precharge voltage is higher than that of the first channel voltage V_CH1 of the first channel line CL1, when second to n^{th} LEDs L12 to L1n connected to the first channel line CL1 emit light, a precharge voltage supplied through the first scan line SL1 is also supplied to the second to n^{th} LEDs L12 to L1n through the short-circuited first LED L11, thereby causing a phenomenon (bright line) in which all LEDs connected to the first channel line CL1 become brighter.

As another example, as shown in FIG. 6B, when the first LED L11 connected to the first channel line CL1 and the first scan line SL1 is short-circuited, and a level of a precharge voltage is lower than that of the first channel voltage V_CH1 of the first channel line CL1, when the second to n^{th} LEDs L12 to L1n connected to the first channel line CL1 emit light, a channel current that should be supplied through the first channel line CL1 is discharged through the short-circuited first LED L11, thereby causing a phenomenon (dim line) in which all LEDs connected to the first channel line CL1 become darker.

Accordingly, as shown in FIG. 2, the LED display driving circuit 120 according to the present disclosure may further include short-circuit detection units 260_1 to 260_3 to reduce image quality degradation caused by a short-circuited LED as described above.

In FIG. 2, the short-circuit detection units 260_1 to 260_3 are illustrated as being disposed for the channel lines CL1 to CL3, but this is merely an example. One short-circuit detection unit may be commonly connected to all of the channel lines CL1 to CL3 to detect a short-circuited LED for each of the channel lines CL1 to CL3. According to such an embodiment, the short-circuit detection unit may be included in the channel driving circuit 124 or may be implemented as a separate component from the channel driving circuit 124.

The short-circuit detection units 260_1 to 260_3 detect whether each of the LEDs included in the display panel 110 is short-circuited and a short-circuit degree. That is, the short-circuit detection units 260_1 to 260_3 may detect not only whether each of the plurality of LEDs is short-circuited, but also a short-circuit degree of the short-circuited LED. For example, the short-circuit detection units 260_1 to 260_3 may determine whether a short-circuited LED is a fully short-circuited LED or a partially short-circuited LED. Here, when a non-short-circuit state is a state in which resistance is infinite, a fully short-circuit state may be a state in which resistance is 0, and a partial short-circuit state may be a state in which resistance is greater than 0 and less than infinity.

Meanwhile, the short-circuit detection units 260_1 to 260_3 may detect whether each of the LEDs is short-circuited and a short-circuit degree during a section before a PWM control signal is supplied to a channel line during driving of a specific scan line. That is, the short-circuit detection units 260_1 to 260_3 may detect whether each of the LEDs is short-circuited and a short-circuit degree using the reference voltage Voff supplied to each channel line during a section before a PWM control signal is supplied to a channel line.

Specifically, the short-circuit detection units 260_1 to 260_3 may determine whether each of the LEDs is short-circuited and a short-circuit degree using the reference voltage Voff which is a channel voltage supplied, through each of the channel lines CL1 to CL3, to the LEDs connected to the scan lines SL1 to SL3 selected by the scan driving circuit 122.

In one embodiment, the short-circuit detection units 260_1 to 260_3 may detect whether each of the LEDs is short-circuited and a short-circuit degree by comparing a channel voltage of each of the channel lines CL1 to CL3 with a plurality of reference voltages at different voltage levels when the scan lines SL1 to SL3 are selected by the scan driving circuit 122.

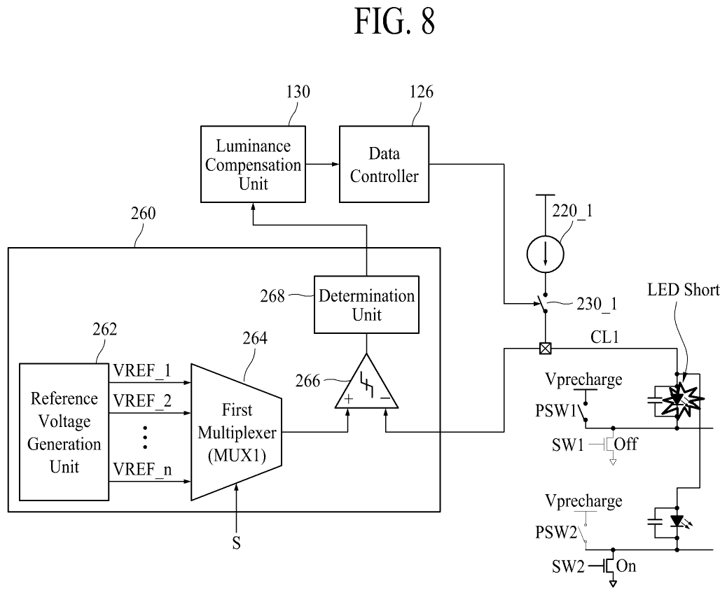

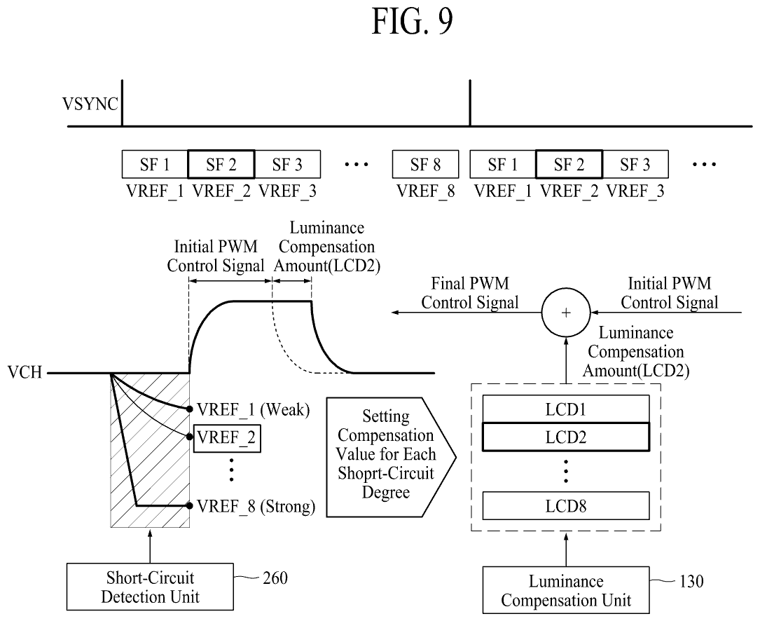

Hereinafter, a configuration of the short-circuit detection unit according to one embodiment of the present disclosure will be described in more detail with reference to FIGS. 8 and 9.

FIG. 8 is a schematic block diagram illustrating the configuration of the short-circuit detection unit according to one embodiment of the present disclosure. FIG. 9 is a diagram illustrating an example in which a short-circuit degree is detected, and a luminance compensation amount is determined based on the short-circuit degree according to one embodiment of the present disclosure.

Since the configurations and operations of the short-circuit detection units 260_1 to 260_3 are the same, the configuration and operation of one short-circuit detection unit will be mainly described below, and the short-circuit detection unit will be denoted by a reference numeral 260.

As shown in FIG. 8, the short-circuit detection unit 260 includes a reference voltage generation unit 262, a first multiplexer 264, a comparator 266, and a determination unit 268.

The reference voltage generation unit 262 generates a plurality of reference voltages VREF_1 to VREF_n to detect whether each of the LEDs is short-circuited and a short-circuit degree. In this case, the reference voltages VREF_1 to VREF_n may have different voltage levels. For example, as shown in FIG. 9, the reference voltage generation unit 262 may generate eight reference voltages VREF_1 to VREF_8 having different voltage levels. In this case, a voltage level of a first reference voltage VREF1 may be a higher value than a voltage level of an n^{th} reference voltage VREF_n.

In one embodiment, the reference voltage generation unit 262 may be a low drop-out (LDO) regulator that generates the plurality of reference voltages VREF_1 to VREF_n having different voltage levels using a reference voltage input from the outside.

The first multiplexer 264 may select any one of the plurality of reference voltages VREF_1 to VREF_n generated by the reference voltage generation unit 262 according to a selection signal S input from the outside and may output the selected reference voltage to the comparator 266. In one embodiment, when one frame includes a plurality of segments as shown in FIG. 3, reference voltages may be mapped to respective segments in a one-to-one correspondence. According to such an embodiment, as shown in FIG. 9, the first multiplexer 264 selects one reference voltage mapped to each of segments SF1 to SF8 among a plurality of reference voltages VREF_1 to VREF_8 and outputs the selected reference voltage to the comparator 266 during driving of each of the segments SF1 to SF8. In this case, the data controller 126 determines which segment is currently operating among the plurality of segments SF1 to SF8, generates the selection signal S corresponding to the currently operating segment, and outputs the selection signal S to the first multiplexer 264.

Meanwhile, in the above-described embodiment, the first to n^{th} reference voltages VREF_1 to VREF_n may be sequentially selected for the segments SF1 to SFN, but in another embodiment, the first to n^{th} reference voltages VREF_1 to VREF_n may be randomly selected for the segments SF1 to SFN irrespective of the order of the segments SF1 to SFN. In this case, the first to n^{th} reference voltages VREF_1 to VREF_n are selected for the segments SF1 to SFN without duplication.

In the example shown in FIG. 9, by determining that a second segment SF2 is currently operating, the data controller 126 generates the selection signal S for selecting the second reference voltage VREF_2 corresponding to the second segment SF2 and outputs the selection signal S to the first multiplexer 264, and the first multiplexer 264 outputs the second reference voltage VREF_2 corresponding to the second segment SF2 to the comparator 266 in response to the selection signal S input from the data controller 126.

The comparator 266 compares one of the reference voltages VREF_1 to VREF_n output from the first multiplexer 264 with a channel voltage V_CH (for example, the reference voltage Voff) and outputs a result of the comparison to the determination unit 268.

The determination unit 268 detects whether LEDs are short-circuited and a short-circuit degree according to the result of the comparison of the comparator 266. In one embodiment, as in the example shown in FIG. 9, the determination unit 268 determines that a corresponding LED is partially short-circuited when the channel voltage V_CH is lower than the first reference voltage VREF_1 having the highest voltage level and higher than the n^{th} reference voltage VREF_n having the lowest voltage level, and determines that a corresponding LED is fully short-circuited when the channel voltage V_CH is lower than or equal to the n^{th} reference voltage VREF_n.

As an example, in the example shown in FIG. 9, the determination unit 268 determines that a corresponding LED is partially short-circuited when the channel voltage V_CH is lower than the first reference voltage VREF_1 and higher than the eighth reference voltage VREF_8, and determines that a corresponding LED is fully short-circuited when the channel voltage V_CH is lower than or equal to the eighth reference voltage VREF_8.

In such an example, the determination unit 268 determines that a short-circuit degree of an LED having the channel voltage V_CH between the first reference voltage VREF_1 and the second reference voltage VREF_2 is less severe than that of an LED having the channel voltage V_CH between the second reference voltage VREF_2 and the third reference voltage VREF_3. In addition, the determination unit 268 determines that a short-circuit degree of an LED having the channel voltage V_CH between the second reference voltage VREF_2 and the third reference voltage VREF_3 is less severe than that of an LED having the channel voltage V_CH between the third reference voltage VREF_3 and the fourth reference voltage VREF_4. Similarly, the determination unit 268 determines that a short-circuit degree of an LED having the channel voltage V_CH between the sixth reference voltage VREF_6 and the seventh reference voltage VREF_7 is less severe than that of an LED having the channel voltage V_CH between the seventh reference voltage VREF_7 and the eighth reference voltage VREF_8.

The determination unit 268 provides, to the luminance compensation unit 130, a result of determining whether there is a short circuit, and a short-circuit degree.

Meanwhile, when a short-circuited LED is detected, the determination unit 268 may generate and store position information of the short-circuited LED based on information of the scan lines SL1 to SL3 and channel lines CL1 to CL3 to which the short-circuited LED is connected. As an example, when a short-circuited LED is connected to the first scan line SL1 and the first channel line CL1, the short-circuit detection unit 260 may generate and store position information of the short-circuited LED as (1,1). Hereinafter, for convenience of description, a scan line to which a short-circuited LED is connected is referred to as a target scan line, and a channel line to which the short-circuited LED is connected is referred to as a target channel line.

The short-circuit detection unit 260 may provide position information of a short-circuited LED to the data controller 126. For convenience of description, it is assumed below that the first LED L11 connected to the first scan line SL1 and the first channel line CL1 is short-circuited. In such an example, the first scan line SL1 becomes the target scan line, and the first channel line CL1 becomes the target channel line.

As described above, according to the present disclosure, since the determination unit 268 may determine not only whether an LED is short-circuited but also a short-circuit degree of the LED, a luminance compensation amount may be adjusted according to the short-circuit degree of the LED, thereby preventing luminance undercompensation or luminance overcompensation of normal LEDs.

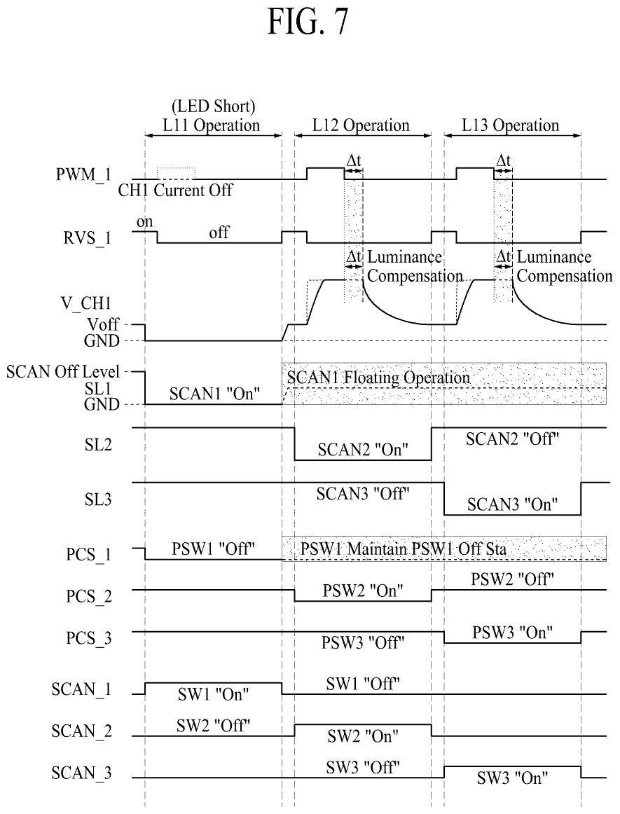

Referring again to FIG. 2, based on position information of the short-circuited LED L11 transmitted from the short-circuit detection units 260_1 to 260_3, the data controller 126 may float the target scan line SL1 when the driving of the target scan line SL1 to which the short-circuited LED L11 is connected is ended. To this end, as shown in FIG. 7, when an emission period of the short-circuited LED L11 ends, and a scan switch of the target scan line SL1 to which the short-circuited LED L11 is connected is turned off again, the data controller 126 generates the precharge control signal PCS_1 for turning off the first precharge switch PSW1 connected to the target scan line SL1 and applies the precharge control signal PCS_1 to the first precharge switch PSW1.

Accordingly, as shown in FIG. 7, after the first scan switch SW1 connected to the target scan line SL1 is turned off, the first precharge switch PSW1 connected to the target scan line SL1 is turned off so that the target scan line SL1 enters a floating state. Accordingly, the target scan line SL1 to which the short-circuited LED L11 is connected is maintained in the floating state until the target scan line SL1 is driven again. In the floating state, a voltage of the target scan line SL1 may be maintained at a lower level than a scan-off voltage, which is a voltage when the first scan switch SW1 connected to the target scan line SL1 is turned off, and a higher level than a voltage of the ground which is a voltage when a scan switch is turned on.

Meanwhile, the data controller 126 may determine which segment is currently operating among the plurality of multiple segments SF1 to SFN to detect whether there is a short circuit and a short-circuit degree, may generate the selection signal S corresponding to the currently operating segment, and may output the selection signal S to the short-circuit detection units 260_1 to 260_3.

In addition, based on the position information of the short-circuited LED L11 transmitted from the short-circuit detection units 260_1 to 260_3, the data controller 126 may block the supply of a channel current through the target channel line CL1 to which the short-circuited LED L11 is connected when the short-circuited LED L11 emits light. To this end, as shown in FIG. 7, the data controller 126 may generate the first PWM control signal PWM_1 for turning off the first PWM switch 230_1 of the target channel line CL1 to which the short-circuited LED L11 is connected when the short-circuited LED L11 emits light. Accordingly, the supply of a channel current to the short-circuited LED L11 is blocked.

In one embodiment, the data controller 126 may also block the supply of the reference voltage Voff through the target channel line CL1 to which the short-circuited LED L11 is connected when the short-circuited LED L11 emits light. According to such an embodiment, when the short-circuited LED L11 emits light, as shown in FIG. 7, the first channel voltage V_CH1 of the target channel line CL1 to which the short-circuited LED L11 is connected may be maintained at a level of the ground GND. To this end, the data controller 126 may generate the first reference voltage application signal RVS_1 for turning off the first reference voltage application switch 250_1 of the target channel line CL1 to which the short-circuited LED L11 is connected when the short-circuited LED L11 emits light, and may transmit the first reference voltage application signal RVS_1 to the first reference voltage application switch 250_1.

As described above, according to the present disclosure, when the short-circuited LED L11 is detected by the short-circuit detection units 260_1 to 260_3, the data controller 126 may turn off the first precharge switch PSW1 connected to the target scan line SL1, to which the short-circuited LED L11 is connected, to maintain the target scan line SL1 in a floating state, and at the same time, may turn off the first PWM switch 230_1 of the target channel line CL1, to which the short-circuited LED L11 is connected, to block the supply of a channel current through the target channel line CL1, thereby preventing the occurrence of a phenomenon in which all LEDs connected to the target channel line CL1 become brighter or darker due to the short-circuited LED L11.

Meanwhile, as described above, as shown in FIG. 2, the LED display driving circuit 120 according to one embodiment of the present disclosure may further include the luminance compensation unit 130 to maximize an effect of reducing image quality degradation as described above.

Specifically, when the LED L11 is short-circuited, due to floating of the target scan line SL1 by the data controller 126, as shown in FIG. 7, during driving of other normal LEDs L12 and L13 connected to the target channel line CL1, a time taken for the first channel voltage V_CH1 to increase from a reference voltage to a maximum value may be shortened as compared to when the LED is not short-circuited.

Accordingly, the luminance compensation unit 130 may compensate the luminance of normal LEDs connected to the target channel line CL1 when any one of the scan lines SL2 and SL3 excluding the target scan line SL1 is selected. In one embodiment, the luminance compensation unit 130 may compensate the luminance of the normal LEDs using different luminance compensation amounts according a short-circuit degree of an LED determined by the short-circuit detection units 260_1 to 260_3.

According to the embodiment described above, the luminance compensation unit 130 may be used to compensate the luminance of the normal LEDs L12 and L13 according to a short-circuit degree of the short-circuited LED L11 during an emission period of the normal LEDs L12 and L13 connected to the target channel line CL1.

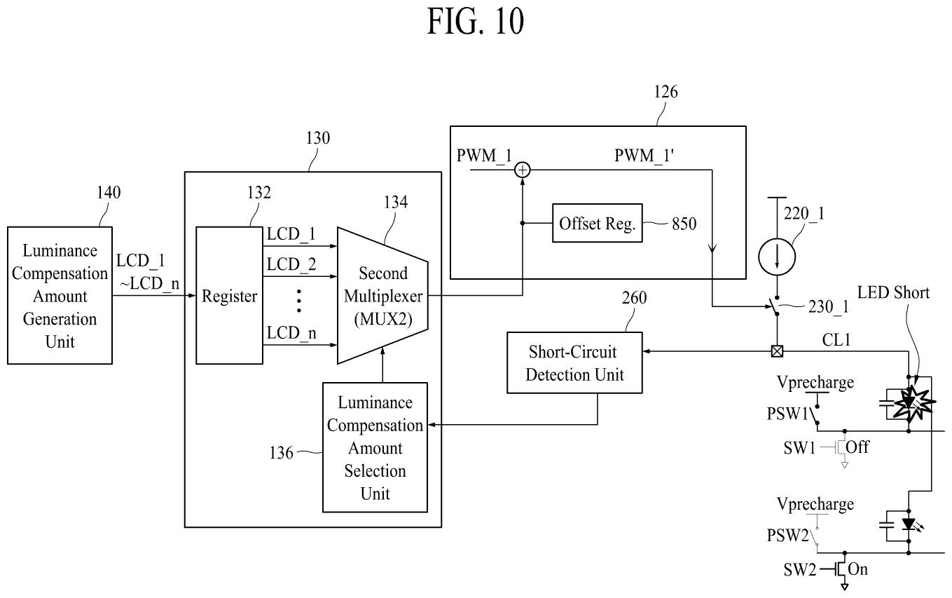

Hereinafter, a configuration of the luminance compensation unit according to one embodiment of the present disclosure will be described in more detail with reference to FIG. 10.

FIG. 10 is a schematic block diagram illustrating the configuration of the luminance compensation unit according to one embodiment of the present disclosure. As shown in FIG. 10, the luminance compensation unit 130 according to one embodiment of the present disclosure includes a register 132, a second multiplexer 134, and a luminance compensation amount selection unit 136.

In the register 132, each luminance compensation amount is mapped and stored according to a short-circuit degree of an LED. That is, when short-circuit detection units 260_1 to 260_n detect whether an LED is short-circuited and a short-circuit degree using n reference voltages VREF_1 to VREF_n, the short-circuit degree may be determined in n stages, and n luminance compensation amounts LCD1 to LCDn may be stored in the register 132 according to the short-circuit degree divided into n stages.

As an example, as in the example shown in FIG. 9, when the short-circuit detection units 260_1 to 260_n detect whether an LED is short-circuited and a short-circuit degree using eight reference voltages VREF_1 to VREF_8, the short-circuit degree may be determined in eight stages, and eight luminance compensation amounts LCD1 to LCD8 may be stored in the register 132 according to the short-circuit degree divided into eight stages.

In one embodiment, a luminance compensation amount according to a short-circuit degree of an LED may be automatically generated when the LED display device 100 operates in a luminance compensation amount generation mode. In this case, the luminance compensation amount generation mode may be performed at a turn-on or turn-off time point of the LED display device 100.

To this end, as shown in FIG. 10, the LED display device 100 according to the present disclosure may further include a luminance compensation amount generation unit 140. The luminance compensation amount generation unit 140 is activated when the LED display device 100 operates in a luminance compensation amount generation mode, generates a luminance compensation amount according to a short-circuit degree of an LED, and stores the generated luminance compensation amount in the register 132.

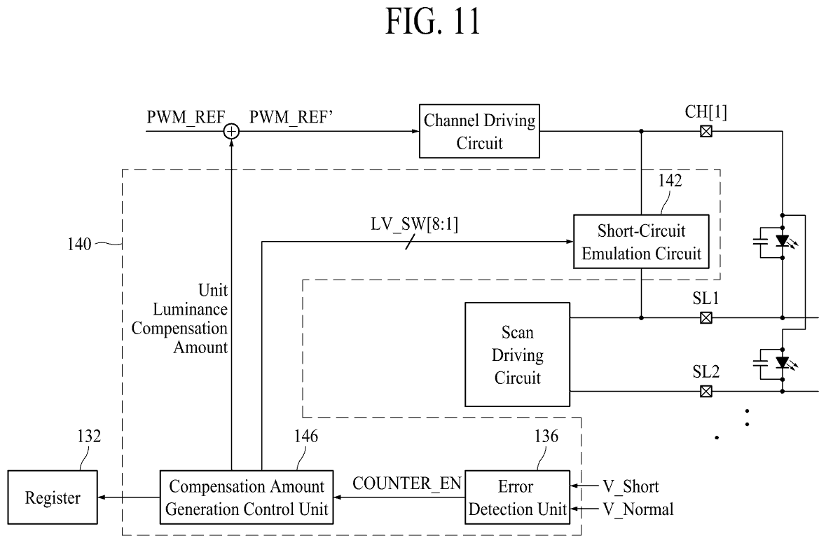

Hereinafter, the luminance compensation amount generation unit 140 according to the present disclosure will be described in more detail with reference to FIG. 11.

FIG. 11 is a schematic block diagram illustrating a configuration of the luminance compensation amount generation unit according to one embodiment of the present disclosure. As shown in FIG. 11, the luminance compensation amount generation unit 140 according to one embodiment of the present disclosure includes a short-circuit emulation circuit 142, an error detection unit 144, and a compensation amount generation control unit 146.

The short-circuit emulation circuit 142 simulates a short circuit of each of LEDs. The short-circuit emulation circuit 142 is connected between the channel lines CL1 to CLm and the scan lines SL1 to SLn. More specifically, the short-circuit emulation circuit 142 may be connected in parallel to each LED disposed in each area in which one channel line of the channel lines CL1 to CLm intersects one scan line of the scan lines SL1 to SLn and may simulate a short-circuit state of each of the LEDs. The short-circuit emulation circuit 142 may include a plurality of resistance adjustment circuits to simulate a short circuit of each of the LEDs.

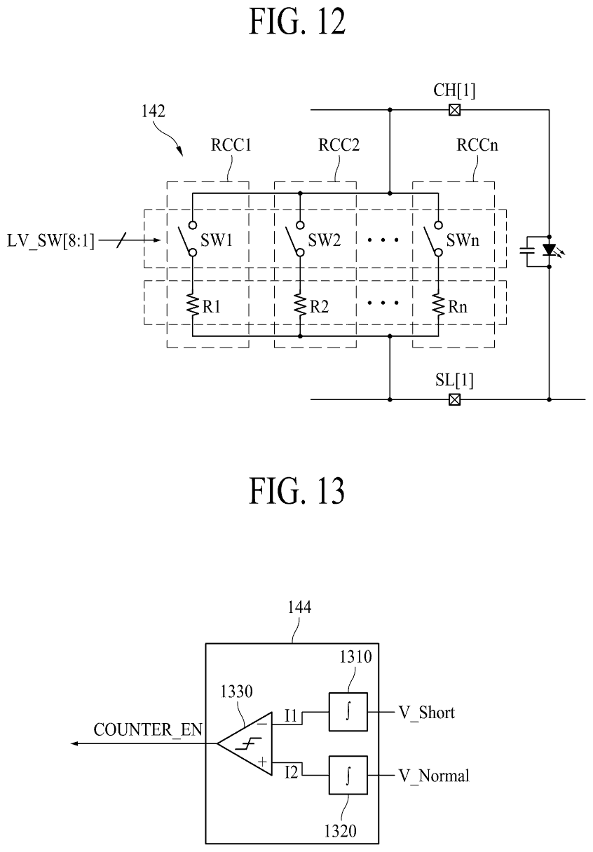

By using the plurality of resistance adjustment circuits, the short-circuit emulation circuit 142 may simulate a short-circuit degree of each of the LEDs by adjusting resistance between the channel lines CL1 to CLm and the scan lines SL1 to SLn. Hereinafter, a configuration of the short-circuit emulation circuit 142 according to one embodiment of the present disclosure will be described in more detail with reference to FIG. 12.

FIG. 12 is a diagram illustrating an example of the short-circuit emulation circuit according to one embodiment of the present disclosure. As shown in FIG. 12, the short-circuit emulation circuit 142 according to one embodiment of the present disclosure may include a plurality of resistance adjustment circuits RCC1 to RCCn connected in parallel with each other. In one embodiment, the number of resistance adjustment circuits RCC1 to RCCn may be adjusted according to a short-circuit degree. As an example, when a short-circuit degree is divided into eight levels, the short-circuit emulation circuit 142 may include eight resistance adjustment circuits RCC1˜RCC8.

Meanwhile, the resistance adjustment circuit RCC1 to RCCn may respectively include switches SW1 to SWn and resistance elements R1 to Rn connected in series to the switches SW1 to SWn, and all of the resistance elements R1 to Rn may be designed to have the same resistance value.

Each of the switches SW1 to SWn may be selectively turned on or off according to control signals LV_SW1 to LV_SWn input from the compensation amount generation control unit 146. In this case, the control signals LV_SW1 to LV_SWn may include a first control signal LV_SW1 that turns on only one switch, a second control signal LV_SW2 that turns on only two switches, and an n^{th} control signal LV_SWn that turns on all n switches.

When only one switch is turned on according to the first control signal LV_SW1, only one resistor element is connected between the channel lines CL1 to CLm and the scan lines SL1 to SLn, and thus resistance between the channel lines CL1 to CLm and the scan lines SL1 to SLn is the highest, thereby simulating a first-level short-circuit state having the weakest short-circuit degree.

Similarly, when only two switches are turned on according to the second control signal LV_SW2, only two resistance elements are connected in parallel with each other between the channel lines CL1 to CLm and the scan lines SL1 to SLn, and thus resistance between the channel lines CL1 to CLm and the scan lines SL1 to SLn is the second highest, thereby simulating a second-level short-circuit state having a second weakest a short-circuit degree.

When all n switches are turned on according to the n^{th} control signal LV_SWn, all n resistance elements R1 to Rn are connected in parallel between the channel lines CL1 to CLm and the scan lines SL1 to SLn, and thus resistance between the channel lines CL1 to CLm and the scan lines SL1 to SLn is minimized, thereby simulating an n^{th} level-short-circuit state having the strongest short-circuit degree.

In FIG. 12, the short-circuit emulation circuit 142 is illustrated as being implemented with a plurality of switches SW1 to SWn and a plurality of resistance elements R1 to Rn, but this is merely an example. The short-circuit emulation circuit 142 may also be implemented with a plurality of transistors. According to such an embodiment, short-circuit states having different levels may be simulated by adjusting the number of transistors turned on according to the control signals LV_SW1 to LV_SWn.

Referring again to FIG. 11, the error detection unit 144 compares a short-circuit channel voltage V_Short of a channel line, to which an LED of which a short circuit is simulated by the short-circuit emulation circuit 142 is connected, with a normal channel voltage V_Normal of a normal channel of which a short circuit is not simulated, and outputs a counter enable signal COUNTER_EN having any one level of a first level and a second level to the compensation amount generation control unit 146 based on a result of the comparison.

In one embodiment, the error detection unit 144 may output the counter enable signal COUNTER_EN having the first level (for example, a, high level) when the short channel voltage V_Short is different from the normal channel voltage V_Normal, and may output the counter enable signal COUNTER_EN having the second level (for example, a low level) when the short channel voltage V_Short is the same as the normal channel voltage V_Normal. Hereinafter, a configuration of the error detection unit 144 according to the present disclosure will be described in more detail with reference to FIG. 13.

FIG. 13 is a schematic block diagram illustrating the configuration of an error detection unit according to one embodiment of the present disclosure. As shown in FIG. 13, the error detection unit 144 according to one embodiment of the present disclosure may include a first integrator 1310, a second integrator 1320, and a comparator 1330.

The first integrator 1310 integrates the short-circuit channel voltage V_Short which is a voltage applied to a corresponding channel line as a PWM reference signal PWM_REF is supplied to a channel line to which an LED of which a short circuit is simulated is connected, and outputs a first integration result according to the integration to a first input terminal I1 of the comparator 1330.

The second integrator 1320 integrates the normal channel voltage V_Normal which is a voltage applied to a normal channel line, and outputs a second integration result according to the integration to a second input terminal I2 of the comparator 1330.

The comparator 1330 compares the first integration result input through the first input terminal I1 with the second integration result input through the second input terminal I2, and generates the counter enable signal COUNTER_EN having a first level or a second level according to a result of the comparison. The comparator 1330 outputs the counter enable signal COUNTER_EN to the compensation amount generation control unit 146.

In one embodiment, when the first integration result is different from the second integration result, the comparator 1330 outputs the counter enable signal COUNTER_EN having the first level (for example, a high level) to the compensation amount generation control unit 146. In addition, the comparator 1330 outputs a counter enable signal COUNTER_EN having the second level (for example, a low level) to the compensation amount generation control unit 146 when the first integration result is the same as the second integration result.

The compensation amount generation control unit 146 controls the short-circuit emulation circuit 142 to adjust a short-circuit degree. In addition, the compensation amount generation control unit 146 generates a luminance compensation amount according to a short-circuit degree and stores the luminance compensation amount in the register 132.

Specifically, the compensation amount generation control unit 146 generates the first control signal LV_SW1 to simulate a short-circuit degree at the weakest level and supplies the first control signal LV_SW1 to the short-circuit emulation circuit 142 to allow only one resistor to be connected between the channel lines CL1 to CLm and the scan lines SL1 to SLn, thereby allowing the resistance between the channel lines CL1 to CLm and the scan lines SL1 to SLn to have the highest value.

In addition, the compensation amount generation control unit 146 generates an n^{th} control signal LV_SWn to simulate a short-circuit degree at the strongest level and supplies the n^{th} control signal LV_SWn to the short-circuit emulation circuit 142 to allow all n resistors to be connected in parallel between the channel lines CL1 to CLm and the scan lines SL1 to SLn, thereby allowing the resistance between the channel lines CL1 to CLm and the scan lines SL1 to SLn to have the lowest value.

The compensation amount generation control unit 146 determines a luminance compensation amount according to each short-circuit degree by increasing or decreasing a luminance compensation amount according to a level of the counter enable signal COUNTER_EN input from the comparator 1330.

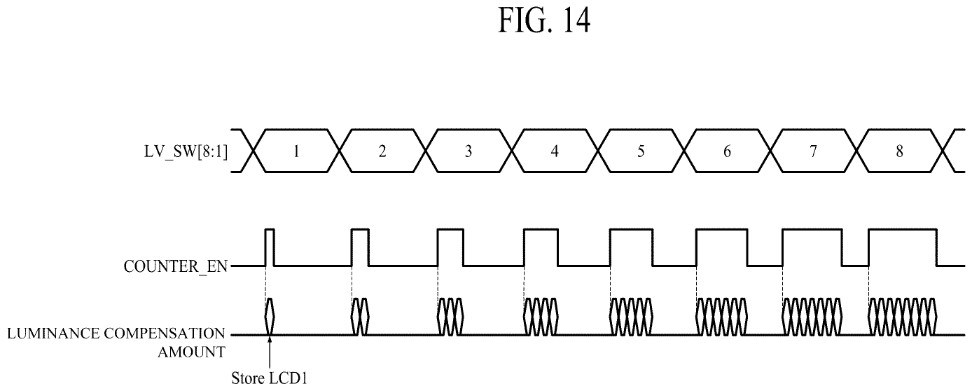

Specifically, as shown in FIG. 14, when the counter enable signal COUNTER_EN having a first level (high level) is output from the comparator 1330, the compensation amount generation control unit 146 determines a luminance compensation amount according to each short-circuit degree by gradually increasing a luminance compensation amount until the counter enable signal COUNTER_EN having a second level (low level) is input from the comparator 1330.

That is, the compensation amount generation control unit 146 supplies a luminance compensation amount to the data controller 126, and the data controller 126 increases an on-section of the PWM reference signal PWM_REF, which is to be supplied to a channel driving circuit of a channel line to which an LED of which a short circuit is simulated is connected, by a unit luminance compensation amount output from the compensation amount generation control unit 146 to generate a final PWM reference signal PWM_REF′, and supplies the generated final PWM reference signal PWM_REF′ to the channel driving circuit of the corresponding channel line. Accordingly, when normal LEDs connected to a corresponding channel line emit light, the short-circuit channel voltage V_Short may increase until it becomes equal to the normal channel voltage V_Normal.

The compensation amount generation control unit 146 determines a luminance compensation amount, which is a luminance compensation amount when the counter enable signal COUNTER_EN having the second level (low level) is input from the comparator 1330, to be a luminance compensation amount corresponding to a corresponding short-circuit degree, and stores the determined luminance compensation amount in the register 132 by mapping the determined luminance compensation amount to the corresponding short-circuit degree.

Accordingly, as can be seen from the waveform diagram shown in FIG. 14, when a short-circuit degree is at a low level (for example, LV1), since a time for which the counter enable signal COUNTER_EN is maintained at a first level is short, a luminance compensation amount is small, and as a short-circuit degree increases to a level (for example, LV8), since a time for which the counter enable signal COUNTER_EN is maintained at the first level is long, a luminance compensation amount increases. That is, it can be seen that a required luminance compensation amount is small when a short-circuit level is low, but a required luminance compensation amount is large when a short-circuit level is high.

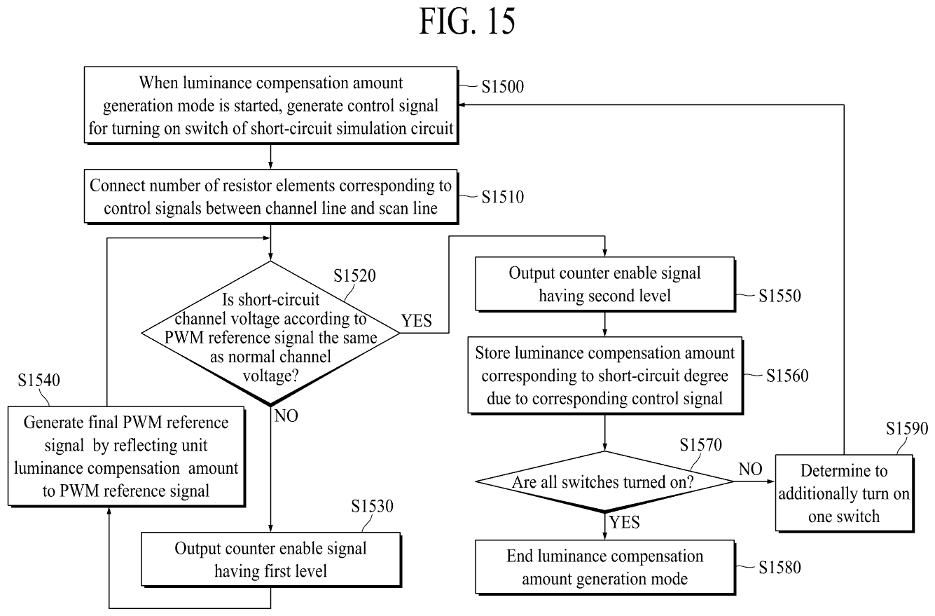

Hereinafter, a method of the luminance compensation amount generation unit generating a luminance compensation amount according to each short-circuit degree according to the present disclosure will be described with reference to FIG. 15.

FIG. 15 is a flowchart illustrating the method of the luminance compensation amount generation unit generating a luminance compensation amount according to each short-circuit degree according to one embodiment of the present disclosure.

When a luminance compensation amount generation mode is started, the luminance compensation amount generation unit 140 generates control signals LV_SW1 to LV_SWn for turning on at least one of the switches SW1 to SWn included in the short-circuit emulation circuit 142 and supplies the signals LV_SW1 to LV_SWn to the short-circuit emulation circuit 142 (S1500).

According to the control signals LV_SW1 to LV_SWn, the number of switches corresponding to the control signals LV_SW1 to LV_SWn are turned on, and a resistor element connected to a corresponding switch is connected between a channel line and a scan line to which an LED of which a short circuit is simulated is connected (S1510).

Thereafter, the luminance compensation amount generation unit 140 compares a short-circuit channel voltage of the channel line, to which the LED of which the short circuit is simulated is connected, with a normal channel voltage of a normal channel line to which a normal LED is connected (S1520), and when the short-circuit channel voltage is different from the normal channel voltage as a result of the comparison, a counter enable signal COUNTER_EN having a first level (high level) is output (S1530).

When the counter enable signal COUNTER_EN having the first level (high level) is output, the luminance compensation amount generation unit 140 adds a predetermined unit luminance compensation amount to a PWM reference signal PWM_REF supplied to the channel line to which the LED of which the short circuit is simulated is connected, generates a final PWM reference signal PWM_REF′, and inputs the a final PWM reference signal PWM_REF′ to a channel driving circuit to which the LED of which the short circuit is simulated is connected (S1550). Afterwards, the luminance compensation amount generation unit 140 repeats operations S1520 to S1550 until the short-circuit channel voltage becomes equal to the normal channel voltage.

Meanwhile, in operation S1520, when the short-circuit channel voltage is the same as the normal channel voltage, the luminance compensation amount generation unit 140 outputs the counter enable signal COUNTER_EN having a second level (low level) (S1540). Thereafter, the luminance compensation amount generation unit 140 stores a luminance compensation amount when the counter enable signal COUNTER_EN having the second level (low level) is output as a luminance compensation amount corresponding to a short-circuit degree due to a corresponding control signal (S1560).

Next, the luminance compensation amount generation unit 140 determines whether all switches SW1 to SWn included in the short-circuit emulation circuit 142 are turned on (S1570), and when it is determined that all the switches SW1 to SWn are turned on, the luminance compensation amount generation mode is ended (S1580). Meanwhile, when all the switches SW1 to SWn included in the short-circuit emulation circuit 142 are not turned on, it is determined to additionally turn on one more switch (S1590), and the process returns to operation S1500 to repeatedly perform subsequent operations.

Referring again to FIG. 10, the second multiplexer 134 outputs one of n luminance compensation amounts LCD1 to LCDn stored in the register 132 to the data controller 126 according to a selection signal S input from the luminance compensation amount selection unit 136.

The luminance compensation amount selection unit 136 generates the selection signal S for selecting one luminance compensation amount corresponding to a short-circuit degree input from the short-circuit detection units 260_1 to 260_3 among n luminance compensation amounts LCD1 to LCDn and outputs the selection signal S to the second multiplexer 134.

As an example, as shown in FIG. 9, when a channel voltage V_CH of an LED is between a second reference voltage VREF_2 and a third reference voltage VERF_3, the short-circuit detection units 260_1 to 260_3 determine that a short-circuit degree of the LED is in a second stage, and generate the selection signal S for selecting a second luminance compensation amount LCD2 mapped to the short-circuit degree in the second stage and output the selection signal S to the second multiplexer 134.

According to the embodiment described above, as shown in FIGS. 7 and 10, the data controller 126 increases an on-section of a first PWM control signal PWM_1, which is to be supplied to the first PWM switch 230_1 of a target channel line CL1, by a luminance compensation amount Δt output from the second multiplexer 134 to generate a final first PWM control signal PWM_1′, and supplies the generated final first PWM control signal PWM_1′ to the first PWM switch 230_1 of the target channel line CL1. Accordingly, the first PWM switch 230_1 connected to the target channel line CL1 is additionally turned on by the luminance compensation amount Δt, and thus a time for which the first channel voltage V_CH1 is maintained at a maximum value when normal LEDs L12 and L13 emit light increases by the luminance compensation amount Δt, thereby increasing the luminance of the normal LEDs L12 and L13. In this case, the luminance compensation amount Δt may be a value corresponding to any one of the first to n^{th} luminance compensation amounts LCD1 to LCDn.

As an example, as shown in FIG. 9, the data controller 126 to which the second luminance compensation amount LCD2 is output from the luminance compensation unit 130 increases an on-section of an initial PWM control signal by the luminance compensation amount LCD2 output from the second multiplexer 134 to generate the final PWM control signal, and supplies the generated final PWM control signal to a PWM switch of a target channel line. Accordingly, a PWM switch connected to a target channel line is additionally turned on by the luminance compensation amount LCD2, and thus a time for which a channel voltage V_CH is maintained at a maximum value when normal LEDs emit light is increased by the luminance compensation amount LCD2, thereby increasing the luminance of the normal LEDs.

Meanwhile, as shown in FIG. 10, when generating the final first PWM control signal PWM_1′, the data controller 126 may additionally reflect an offset value stored in an offset register 850 to an initial first PWM control signal PWM_1.

In the above-described embodiment, it has been described that an on-section of the initial first PWM control signal PWM_1 increases only by the luminance compensation amount Δt, but the on-section of the initial first PWM control signal PWM_1 may also decrease by the luminance compensation amount Δt.

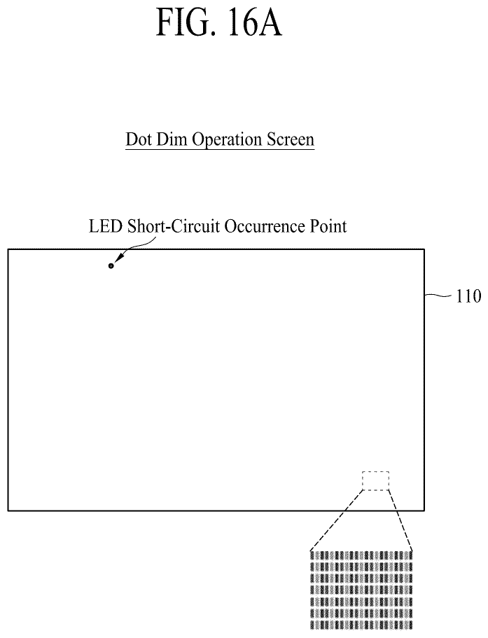

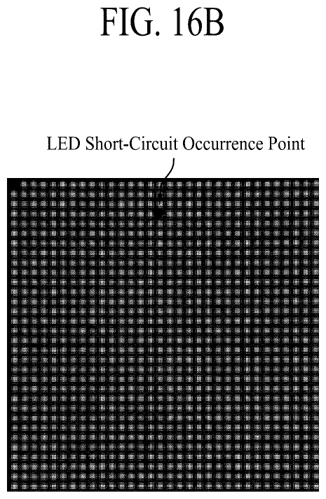

As described above, according to the present disclosure, as shown in FIGS. 16A and 16B, only a dot defect (dot dim) occurs in which only a short-circuited LED does not emit light, and a line defect (line dim) in which the luminance of all other normal LEDs connected to a target channel line to which the short-circuited LED is connected changes is prevented, thereby achieving image quality close to normal without repairing or replacing the LED.

According to the present disclosure, since a short circuit of an LED is detected using a plurality of reference voltages at different voltage levels, not only a fully short-circuited LED but also a partially short-circuited LED can be accurately detected.

In addition, according to the present disclosure, by floating a target scan line connected to a short-circuited LED during a non-emission period of the short-circuited LED, it is possible to prevent the occurrence of a line defect (line dim) in which the luminance of all other normal LEDs connected to the same channel line as the short-circuited LED changes, thereby achieving image quality close to normal without repairing or replacing the short-circuited LED.

In addition, according to the present disclosure, when normal LEDs connected to a target channel line emit light, the luminance of the normal LEDs can be compensated using different luminance compensation amounts according to a short-circuit degree of a short-circuited LED, thereby preventing luminance undercompensation or luminance overcompensation of the normal LEDs and preventing the occurrence of image quality degradation to a short circuit of an LED.

What is claimed is:

1. A light-emitting diode (LED) display driving circuit comprising:
a channel driving circuit configured to supply a channel current to each of a plurality of channel lines to which a plurality of LEDs are connected according to a pulse width modulation (PWM) control signal;
a scan driving circuit including a plurality of scan switches configured to selectively drive each scan line to cause the plurality of LEDs to emit light, and a plurality of precharge switches which are turned on when the scan switches are turned off and supply a precharge voltage to the scan lines;
a short-circuit detection unit configured to detect whether the plurality of LEDs are short-circuited and a short-circuit degree;
a data controller which, when a short-circuited LED is detected, turns off a precharge switch of a target scan line, to which the short-circuited LED is connected, when the scan switch of the target scan line is turned off, and maintains the target scan line in a floating state; and
a luminance compensation unit configured to compensate luminance of normal LEDs connected to the target channel line to which the short-circuited LED is connected according to a short-circuit degree of the short-circuited LED during driving of the scan lines excluding the target scan line.

2. The LED display driving circuit of claim 1, wherein the short-circuit detection unit detects whether the LEDs are short-circuited and the short-circuit degree by comparing a channel voltage of each channel line with a plurality of reference voltages at different voltage levels when a specific scan line is driven by the scan driving circuit.

3. The LED display driving circuit of claim 1, wherein the short-circuit detection unit includes:
a reference voltage generation unit configured to generate a plurality of reference voltages at different voltage levels;
a comparator configured to compare any one reference voltage of the plurality of reference voltages with a channel voltage of each channel line; and
a determination unit configured to determine whether the LEDs are short-circuited and the short-circuit degree based on a comparison result of the comparator.

4. The LED display driving circuit of claim 3, wherein one frame is divided into a plurality of segments and driven, and
the short-circuit detection unit further includes a first multiplexer configured to select one reference voltage mapped to each segment among the plurality of reference voltages according to a selection signal input from the data controller and output the selected reference voltage to the comparator during driving of each segment.

5. The LED display driving circuit of claim 1, wherein one frame is divided into a plurality of segments and driven,
the short-circuit detection unit detects whether the LEDs are short-circuited and the short-circuit degree using a reference voltage supplied to each channel line during a section before the PWM control signal is supplied to the channel line when the scan line is driven for each segment, and
the reference voltage has a reference voltage level that is higher than a ground level.

6. The LED display driving circuit of claim 1, wherein the luminance compensation unit includes:
a register in which a luminance compensation amount is mapped according to the short-circuit degree;
a luminance compensation amount selection unit configured to generate a selection signal for selecting a luminance compensation amount corresponding to the short-circuit degree; and
a second multiplexer configured to select one luminance compensation amount corresponding to the short-circuit degree from the register in response to the selection signal and output the one luminance compensation amount, and
the data controller generates a final PWM control signal for controlling a PWM switch connected to the target channel line by adjusting an on-section of an initial PWM control signal by the selected luminance compensation amount.

7. The LED display driving circuit of claim 1, wherein the channel driving circuit includes:
a plurality of channel current sources disposed for each channel line and configured to generate the channel current to be supplied through each channel line using an externally supplied voltage; and
a plurality of PWM switches connected between each channel line and a corresponding channel current source and turned on or off according to the PWM control signal to control an amount of the channel current supplied to each channel line, and
the data controller generates the PWM control signal to turn off the PWM switch of the target channel line to which the short-circuited LED is connected during a turn-on section of the scan switch of the target scan line.

8. The LED display driving circuit of claim 1, wherein, when a specific scan line is selected by the scan driving circuit, a channel voltage of each channel line according to the channel current supplied through each channel line increases from a reference voltage level higher than a ground level when the channel current increases, and decreases to the reference voltage level when the supply of the channel current is stopped.

9. A light-emitting diode (LED) display device comprising:
a display panel including a plurality of LEDs; and
an LED display driving circuit configured to supply a channel current to the plurality of LEDs to cause the plurality of LEDs to emit light,
wherein the LED display driving circuit includes:
a channel driving circuit configured to supply the channel current through each channel line according to a pulse width modulation (PWM) control signal;
a scan driving circuit including a plurality of scan switches configured to selectively drive each scan line to cause the plurality of LEDs to emit light, and a plurality of precharge switches which are turned on when the scan switches are turned off and supply a precharge voltage to the scan lines;
a short-circuit detection unit configured to detect whether the plurality of LEDs are short-circuited and a short-circuit degree;
a data controller which, when a short-circuited LED is detected, turns off a precharge switch of a target scan line, to which the short-circuited LED is connected, when the scan switch of the target scan line is turned off, and maintains the target scan line in a floating state; and
a luminance compensation unit configured to compensate luminance of normal LEDs connected to the target channel line to which the short-circuited LED is connected according to a short-circuit degree of the short-circuited LED during driving of the scan lines excluding the target scan line.

10. The LED display device of claim 9, wherein one frame is divided into a plurality of segments and driven, and
the short-circuit detection unit includes:
a reference voltage generation unit configured to generate a plurality of reference voltages at different voltage levels;
a comparator configured to compare any one reference voltage of the plurality of reference voltages with a channel voltage of each channel line;
a first multiplexer configured to select one reference voltage mapped to each segment among the plurality of reference voltages according to a selection signal input from the data controller and output the selected reference voltage to the comparator during driving of each segment; and
a determination unit configured to determine whether the LEDs are short-circuited and the short-circuit degree based on a comparison result of the comparator.

11. The LED display device of claim 9, wherein the luminance compensation unit includes:
a register in which a luminance compensation amount is mapped according to the short-circuit degree;
a luminance compensation amount selection unit configured to generate a selection signal for selecting a luminance compensation amount corresponding to the short-circuit degree; and
a second multiplexer configured to select one luminance compensation amount corresponding to the short-circuit degree from the register in response to the selection signal, and
the data controller generates a final PWM control signal for controlling a PWM switch connected to the target channel line by adjusting an on-section of an initial PWM control signal by the selected luminance compensation amount.

12. The LED display device of claim 9, wherein one frame is divided into a plurality of segments and driven,
the short-circuit detection unit detects whether the LEDs are short-circuited and the short-circuit degree using a reference voltage supplied to the channel line during a section before the PWM control signal is supplied to the channel line when the scan line is driven for each segment, and
the reference voltage has a reference voltage level that is higher than a ground level.
